(19) United States
(12) Patent Application Publication
(10) Pub. No.: US 2002/0188693 A1
(43) Pub. Date: Dec. 12, 2002

(54) System and method for requesting service for imaging data to a web service

(76) Inventors: Shell S. Simpson, Boise, ID (US); Ward S. Foster, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,106

(22) Filed: Jun. 4, 2001

(51) Int. Cl. G06F 15/16

(52) U.S. Cl. 709/217

(57) ABSTRACT

A system and method is described for preparing imaging data for servicing imaging data stored in a personal imaging repository by a requested web service operably connected to a computing device requesting the service. The present invention includes a computing device for requesting service with the requested web service, a personal imaging repository associated with a particular user profile for storing imaging data that is to be accessed by the requested web service, user information for allowing access to the personal imaging repository, and a requested web service for servicing the imaging data stored in the personal imaging repository. The personal imaging repository is an exchange infrastructure between the imaging data and available web services on the Internet.

The present invention generally relates to an improved system and method for servicing imaging data stored in a personal imaging repository. More specifically, it relates to an improved system and method for servicing imaging data stored in a personal imaging repository by a requested web service operably connected to a computing device requesting the service.

Computing devices are becoming more mobile as technology allows them to be faster, smaller and lighter. The sizes, capacities and features of these computing devices vary greatly, ranging from the typical desktop computer to a hand-held personal digital assistant (“PDA”). Nevertheless, even with all the improvements in current computing devices, services to these devices generally require preconfiguration before service can be utilized, and each service requires a specific preconfiguration. In other words, each service may require a distinct preconfiguration process necessitating separate software installation. For example, each model of various printers, even when manufactured by the same company, may require different drivers, and in some cases, software applications. As another example, each requested web service may require different drivers and preconfiguration.

Many currently available printing systems implemented with a web interface use specialized printer driver devices and port monitors to capture the imaging information for uploading to the server providing the printing. However, with these current systems, the imaging information is fundamentally associated with the server. As a result, the imaging information is limited for use only with the server to which the imaging data was uploaded.

One of the most recognized printing systems implemented with a web interface currently known today is the web site “Mimeo.com” provided by Mimeo.com, Inc. The Mimeo.com site is an online copy center where users can print a document straight from their desktop application to the Mimeo.com printers. Before one can use the Mimeo.com service, specific software must first be downloaded and installed onto the user's computer. Once the software is installed, users can choose a Mimeo.com printer from the print menu when printing from their desktop application. Users can then select the Mimeo.com printer just as if it were a typical printer. Once selected, another menu then pops up on users' screens that enables the user to select the current document and transfer it to the Mimeo.com web site. At the site, the document is transferred to a storage location assigned to the user by the Mimeo.com server, and a web content with a preview of the document and printing options are displayed to the user. The document remains in the storage location for user selection for a limited time.

One problem with the Mimeo.com system is that the downloaded document can be used only on the Mimeo.com web site and users are not allowed to send the downloaded document to another online service. Another problem is that the user must choose a specific printer, and the document is downloaded based on the chosen specific printer. For example, if the user chooses a black and white printer, the downloaded document can be used only with the black and white printers. If the user wishes to have a color printer to print the same document, the document must be printed and downloaded again with the color printer chosen. This can be burdensome, inflexible and wasteful of bandwidth.

Another known printing system is provided on the HDE.com website by HDE Inc. This site provides an Internet printing solution that allows printing through a firewall system over the Internet. Special software must also be installed on the end-user's computer before the print jobs can be transmitted to a destination printer over the Internet. In addition, the destination printer also contains special firmware to receive these transmitted print jobs. Such preconfiguration is very burdensome and inflexible. Furthermore, it is particularly inconvenient for users of mobile computing devices, which may require connection to different network environments at various location sites.

### BRIEF SUMMARY OF THE INVENTION

The present invention is directed to an improved system and method for servicing imaging data stored in a personal imaging repository. More particularly, the present invention relates to a system and method for servicing imaging data stored in a personal imaging repository by a requested web service operably connected to a computing device requesting the service.

The present invention provides a system that includes a computing device for requesting service with the requested web service, a personal imaging repository associated with a particular user profile for storing imaging data that is to be accessed by the requested web service, user information for allowing access to the personal imaging repository, and a requested web service for servicing the imaging data stored in the personal imaging repository. The personal imaging repository acts as an exchange infrastructure between the imaging data and the available web services on the Internet.

The present invention further provides a method that includes the steps of requesting service from the requested web service by the computing device, sending user information to the requested web service, accessing the personal imaging repository using the user information by the requested web service, and servicing the selected imaging data by the requested web service responsive to user selection from the computing device.

### DESCRIPTION OF THE DRAWINGS

FIG. 1 is an architectural diagram of a network system in which the present invention can be implemented;

FIG. 2 is a flowchart illustrating the preferred functionality of the method of the present invention;

FIG. 3 is a flowchart illustrating the preferred functionality of the access method of the present invention shown in FIG. 2; and,

FIG. 4 is another flowchart illustrating the preferred functionality of the access method of the present invention shown in FIG. 2.

### GLOSSARY OF TERMS AND ACRONYMS

The following terms and acronyms are used throughout the detailed description:

Client-Server.

A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on the computer of a user; the program which responds to browser requests by serving Web pages, or other types of Web content, is commonly referred to as a “Web server.”

Composition Store.

Composition store refers to a network service or a storage device for storing imaging composition(s) that can be accessed by the user or other web services.

Content.

A set of executable instructions that is served by a server to a client and that is intended to be executed by the client so as to provide the client with certain functionality. Web content refers to content that is meant to be executed by operation of a Web browser. Web content, therefore, may non-exhaustively include one or more of the following: HTML code, SGML code, XML code, XSL code, CSS code, Java applet, JavaScript and C-“Sharp” code.

Exchange Infrastructure.

An exchange infrastructure is a collection of services distributed throughout a network that stores imaging data associated with a particular user through a user profile.

Hyperlink.

A navigational link from one document to another, from one portion (or component) of a document to another, or to a Web resource, such as a Java applet. Typically, a hyperlink is displayed as a highlighted word or phrase that can be selected by clicking on it using a mouse to jump to the associated document or document portion or to retrieve a particular resource.

Hypertext System.

A computer-based informational system in which documents (and possibly other types of data entities) are linked together via hyperlinks to form a user-navigable “web.”

Imaging Composition.

An imaging composition comprises links to imaging data serviced as a single unit.

Imaging Data.

Imaging data refers to digital data capable of being represented as two dimensional graphics, such as a Portable Document Format (“PDF”) file or a Joint Photographic Experts Group (“JPEG”) file.

Imaging Data Store.

Imaging data store refers to a network service or a storage device for storing imaging data that can be accessed by the user or other network services. The imaging data store preferably accepts the imaging data in multiple standard file formats, and the imaging data is converted into these file formats when necessary depending on the implementation.

Internet.

A collection of interconnected or disconnected networks (public and/or private) that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”).

Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Site.

A computer system that serves informational content over a network using the standard protocols of the World Wide Web. Typically, a Web site corresponds to a particular Internet domain name, such as “HP.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users. Importantly, a Web Site can have additional functionality, for example, a Web site may have the ability to print documents, scan documents, etc.

HTML (HyperText Markup Language).

A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

HTTP (HyperText Transport Protocol).

The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document or file located at the specified URL.

URL (Uniform Resource Locator).

A unique address which fully specifies the location of a file or other resource on the Internet or a network. The general format of a URL is protocol://machine address:port/path/filename.

User Information.

User information is identification and security information used in accessing imaging composition(s) and imaging data associated with a particular user profile. It is preferably accessed either directly or indirectly through methods provided by an extension component integrated into the web browser.

PDA (Personal Digital Assistant).

A small hand-held computer used to write notes, track appointments, email and web browser with generally with far less storage capacity than a desktop computer.

Personal Imaging Repository.

A personal imaging repository is a conceptual term describing the exchange infrastructure used to exchange imaging composition and imaging data with web services. Users are associated with their imaging data through user profiles.

### DETAILED DESCRIPTION

Broadly stated, the present invention is directed to an improved system and method for servicing imaging data stored in a personal imaging repository by a requested web service operably connected to a computing device requesting the service. The system and method provide services to the selected imaging data stored in a personal imaging repository, which acts as an exchange infrastructure between the imaging data and available web services on the Internet. Once the imaging data is stored in the personal imaging repository, it can be freely used by other web services or the user at a later time. Furthermore, it is no longer necessary for the imaging data to be downloaded to the requested web service, since services are configured to directly access the personal imaging repository.

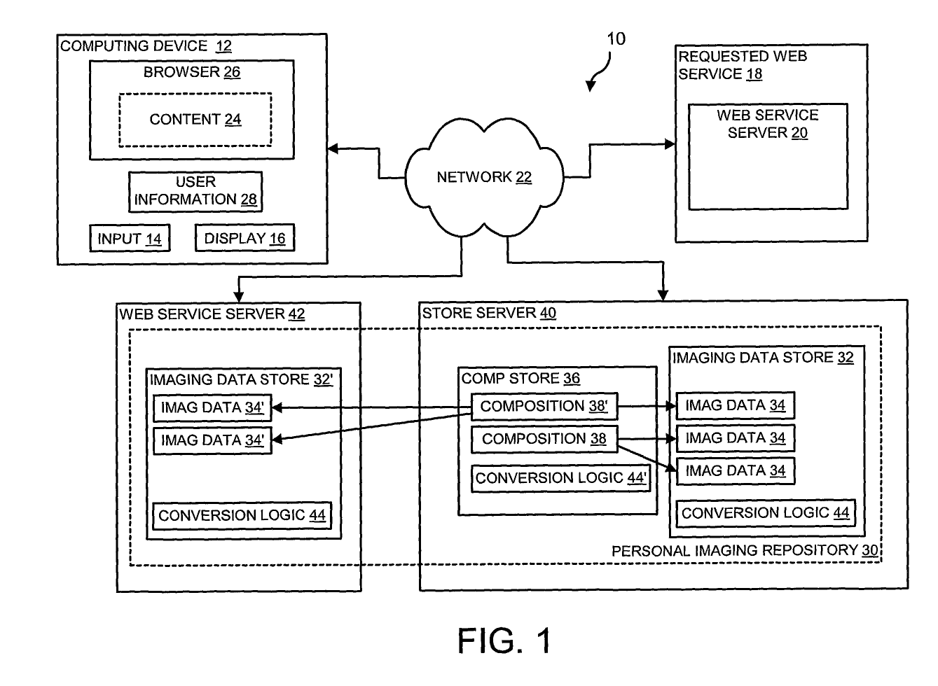

The preferred network system in which the present invention can be implemented is shown in FIG. 1 and indicated generally at 10. The illustrated current preferred network system is just one of many ways of implementing the network topology of the present invention. As a result, it should be understood that other network topologies are contemplated and are within the scope of the present invention. As shown in FIG. 1, a computing device 12 including the typical components of a general computer, such as an input interface 14 and display interface 16, is connected to a web service 18 provided by a web service server computer 20 via a network 22. The computing device 12 establishes a connection with the web service server computer 20 upon request for a web content 24 from the requested web service 18. The computing device 12 includes a browser 26 that can display and execute the web content 24, which causes the browser to send user information stored on the computing device to the requested web service 18.

Because of the various services that each web service can offer, the web content 24 that is available from each web service differs greatly depending upon the services a particular web site offers. In fact, the range of services that the web services can offer are limitless. For example, the most common services envisioned are printing or copying. However, other services, such as email services, scanning services or auction services, are contemplated and should be considered within the scope of the present invention.

The user information 28 comprises identification and security information used in accessing imaging composition(s) and imaging data stored in a personal imaging repository 30 associated with a particular user profile. The personal imaging repository 30 preferably includes an imaging data store 32, 32′, i.e., a digital memory, for storing the imaging data 34, 34′ and a composition store 36 for storing imaging composition(s) 38, 38′ of the imaging data that are serviced as a single unit. The personal imaging repository 30 is provided by a store server 40 that is operatively connected to the network 22. An imaging composition 38, 38′ preferably comprises links to the imaging data 34, 34′, which can be located at another web site. As a result, the composition store 36 stores only the imaging compositions 38, 38′. The imaging data store 32, on the other hand, is any imaging data store located on any computer that contains the imaging data 34, 34′. More specifically, each web service can have its own imaging data store 34′ available to the public.

For example, at some previous time, a user may have printed articles from a web service site providing a web service server 42, resulting in an imaging composition being created and stored in the user's composition store 38′. Since the created imaging composition 38′ contains only the link to the imaging data 34′ for the articles stored on the web service site and another imaging data 34 stored on the store server 40, the imaging data 34′ for the articles is not in the imaging data store 32′ located on the store server 40. Rather, the imaging data 34′ is stored in the imaging data store 32′ located on the web service server 42. Of course, users will have an imaging data store 32 that belongs to their user identification where they can store imaging data 34, which is the imaging data store shown in the store server 40. As a result, the term “personal imaging repository” 30 is meant as a conceptual term for an exchange infrastructure between the imaging data and the available web services on the Internet. Similarly, the term “web,” which denotes millions of distinct servers that comprise the web, does not actually do anything itself. In the present invention, the servers serving the imaging data store 32 and the composition store 36 are physical implementations of the personal imaging repository 30 as a concept.

Because the web services are configured to access the personal imaging repository when a service is requested, the personal imaging repository 30 becomes the exchange infrastructure for the imaging data for the web services that are available on the Internet. Users no longer must remember the directory in which they placed their imaging data. When the user requests web services for any of the imaging data stored in the personal imaging repository 30, the requested web service is configured to access the imaging data indicated by the selected imaging composition stored in the personal imaging repository. Put differently, only the selected imaging composition will be serviced by the requested web service. Furthermore, once the imaging data has been serviced once, it is saved in the personal imaging repository, and can be freely utilized by any other available web services.

Also as shown, both the imaging data store 32, 32′ and the composition store 36 include a conversion logic 44, 44′ for converting the imaging data in a requested specified format if necessary. It is preferred that the imaging data is available in a plurality file formats, such as JPEG, Graphics Interchange Format (“GIF”), Portable Network Graphics Format (“PNGF”), Tagged Image File Format (“TIFF”), PDF and Microsoft Windows bitmap format (“BMP”). Therefore, the specified format can be any of the preferred plurality of file formats indicated. The composition store 36 preferably performs the conversion for the imaging data. However, the imaging data store, other web services or devices can also convert the imaging data depending on the chosen implementation. It should, therefore, be understood that other implementations can be used and within the scope of the present invention.

It should be further noted that the personal imaging repository 30 can represent any type of data storage device. In fact, the data storage device does not necessarily have to be located within the store server 40. The personal imaging repository 30 can be located, for example, on another storage medium, which the client machine can access through alternative communication links. It is currently preferred to include the personal imaging repository 30 with the store server 40, which can be accessed by any computing devices or servers with the user information 28. However, the user information need not physically reside on a computing device. Other implementations of the user information are also available, such as a login and password, and these implementations are within the scope of the present invention.

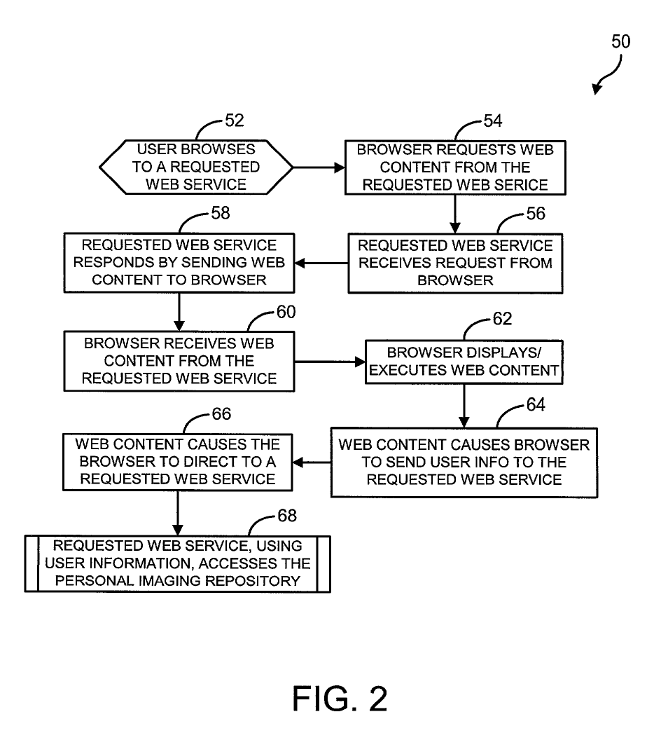

Turning to an important aspect of the present invention, a flow chart of the preferred functionality of the method used with the present invention is shown in FIG. 2, and indicated generally at 50. The process is initiated when the browses to a requested web service (block 52). Accordingly, the browser first requests web content from the requested web service (block 54), and the request is received by the requested web service (block 56). The requested web service accordingly responds to the request with web content being sent to the browser (block 58). After the browser receives the web content (block 60), it is displayed and executed by the browser (block 62). The web content first causes the browser to send user information that is stored on the computing device to be sent to the requested web service (block 64). Then, the web content also causes the browser to be directed to a requested web service (block 66).

It should be noted that although in this implementation, the web content causes the user information to be sent, there are other ways to trigger the user information to be sent. For example, when the computing device requests the requested web service, the computing device can be configured to sent the user information directly to the requested web service without the need of the browser or the web content to initiate the sending of the user information. These other implementations are contemplated are should be considered within the scope of the present invention.

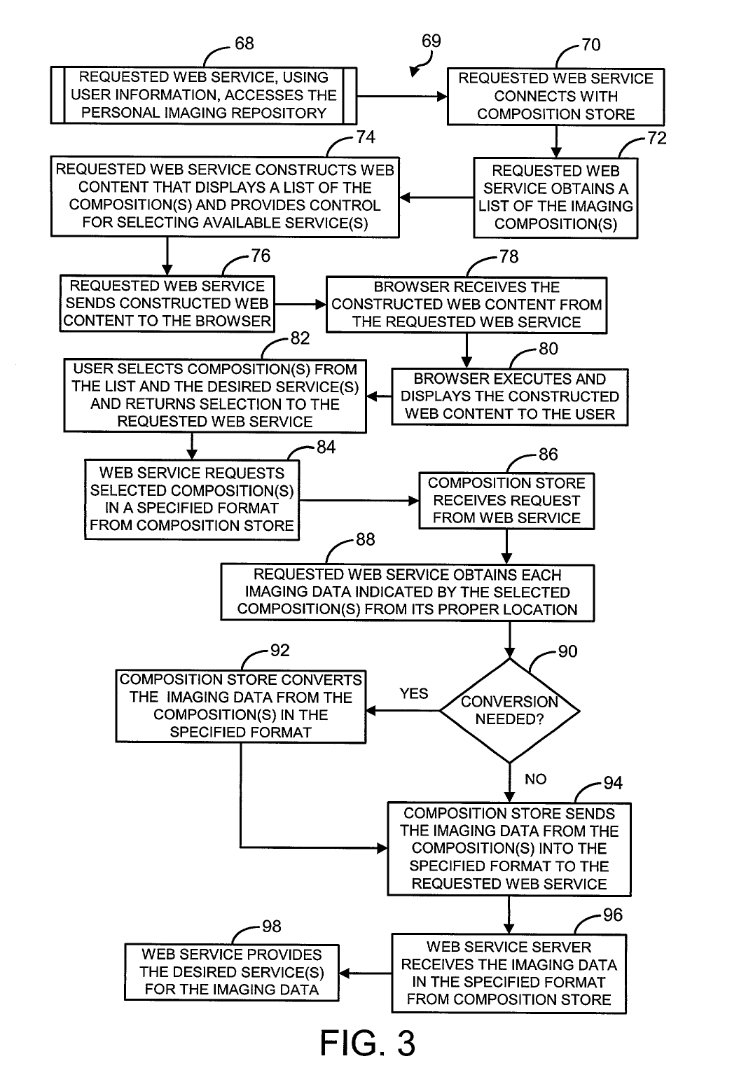

A flow chart of the preferred functionality of a service method for accessing the personal imaging repository is shown in FIG. 3, and indicated generally at 50. As shown in FIGS. 2 and 3, the requested web service, using the user information sent from the browser, accesses the personal imaging repository (block 68), more specifically, for services of the imaging data. The requested web service first connects with the composition store of the personal imaging repository (block 70), and obtains a list of the imaging composition(s) (block 72). After a list is compiled, the requested web service constructs a web content that displays a list of the imaging composition(s) stored in the composition store and provides control for selecting the available services from the web service (block 74). The constructed web content is sent to the browser (block 76). After the browser receives the constructed web content (block 78), it is executed and displayed to the user (block 80). The user returns the selections of the imaging composition(s) from the list and the desired service(s) to the web service (block 82), and the requested web service accordingly requests the selected composition(s) in a specified form from the composition store (block 84).

It should be noted that there are various ways to implement the present invention. For example, the selection of the imaging compositions and selection of the desired services can be done at separate web services. In other words, the user can use a web service to obtain and select imaging compositions, and while another web service to select the available desired services for the selected imaging compositions. These various implementations are contemplated and are within the scope of the present invention.

After the composition store receives the request from the requested web service (block 86), each imaging data indicated by the selected imaging composition(s) is then obtained from its proper location by the requested web service (block 88). Once the imaging data is obtained, it is next determined whether a conversion is needed for the imaging data (block 90). If so, the composition store converts the imaging data from the selected composition(s) in the requested specified format (block 92). The composition store finally sends the imaging data from the selected imaging composition(s) in the specified format to the requested web service (block 94). The web service server receives the imaging data in the specified format from the composition store (block 96), and the requested web service provides the desired service(s) for the imaging data (block 98).

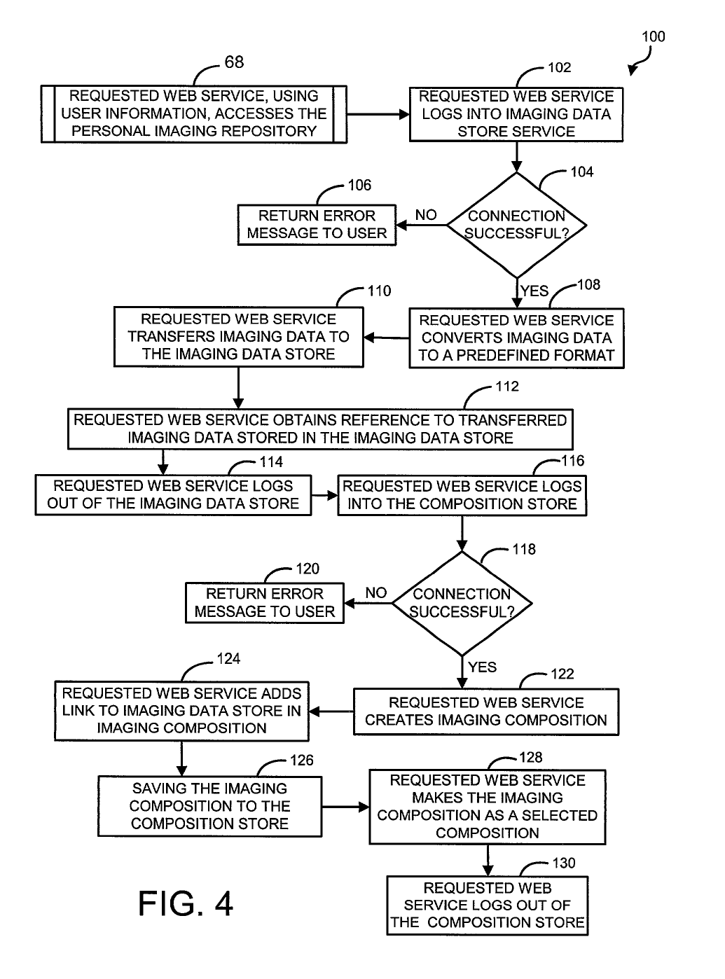

A flow chart of the preferred functionality of an add method for accessing the personal imaging repository is shown in FIG. 4, and indicated generally at 100. As shown in FIGS. 2 and 4, the requested web service, using the user information sent from the browser, accesses the personal imaging repository (block 68), more specifically, for adding the imaging data. The requested web service first logs into the imaging data store service (block 102). It is then determined whether the connection to the imaging data store is successful (block 104), and if not, an error message is sent to the user (block 106). Once it is established that a connection to the imaging data store is successful (block 104), the requested web service converts the imaging data into a predefined format, such as JPEG, (block 108) and accordingly transfers the imaging data in the converted format to the imaging data store (block 110). The requested web service obtains a reference to the transferred imaging data (block 112), and it will log out of the imaging data store (block 114) and log into the composition store (block 116). Again, it is determined whether the connection to the composition store is successful (block 118). Another error message is sent to the user (block 120) if the connection was unsuccessful (block 118). After a successful connection to the composition store (block 118), the requested web service creates an imaging composition (block 122) and adds the reference to the imaging data stored in the imaging data store obtained earlier in the imaging composition (block 124). This newly created imaging composition is then saved to the composition store (block 126), and further set as a selected imaging composition in the composition store (block 128). Because the imaging composition is set as the selected composition, it will be used by web services that make use of the selected composition of the personal imaging repository. Finally, the requested web service logs out of the composition store (block 130).

It should be noted that the order of the access method can be varied and changed depending on the implementation of the present invention. An alternative method is logging into either one of the stores, and upon successful connection, the requested web service then immediately logs into the other store prior to performing any further steps. More specifically, for example, the requested web service can first log into the imaging data store. Upon a successful connection with the imaging data store, the requested web service next logs into the composition store. Once it is established that the requested web service has successfully logged into both the imaging data store and the composition store, only then would the remaining steps be processed. This alternative method ensures that the imaging data is not unnecessarily transferred to the imaging data store when an imaging composition of the transferred imaging data can not be added to the composition store due to a connection failure. This method is especially preferred when the composition store resides on a separate location other than the imaging client as shown in FIG. 2.

From the foregoing description, it should be understood that an improved system and method for preparing imaging data for printing to a requested web service has been shown and described, which has many desirable attributes and advantages. The system and method provides for servicing imaging data stored in a personal imaging repository by a requested web service operably connected to a computing device requesting the service. The imaging data is stored in a personal imaging repository, which acts as an exchange infrastructure between the imaging data and available web services. Because the web services are configured to access the personal imaging repository for the imaging data using the user information, it is no longer necessary for the imaging data to be uploaded to the requested web service. Rather, once the imaging data is stored in the personal imaging repository, it can be used by any other web services or the user at a later time.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A system for servicing imaging data stored in a personal imaging repository by a requested web service operably connected to a computing device requesting the service, comprising:
a computing device for requesting service with the requested web service;
a personal imaging repository associated with a particular user profile for storing imaging data that is to be accessed by the requested web service;
user information for allowing access to said personal imaging repository; and,
a requested web service for servicing the imaging data stored in said personal imaging repository;
wherein said personal imaging repository is an exchange infrastructure between the imaging data and available web services.

2. The system as defined in claim 1 wherein said requested web service sends a web content responsive to a service request from said computing device.

3. The system as defined in claim 2 wherein said web content causes said user information to be sent to said web service.

4. The system as defined in claim 3 wherein said web service accesses said personal imaging repository using said user information.

5. The system as defined in claim 1 wherein said web service is provided through a web server.

6. The system as defined in claim 1 wherein said computing device further includes a web browser for displaying and executing web content from the available web services.

7. The system as defined in claim 1 wherein said personal imaging repository provides the imaging data in a plurality of file formats.

8. The system as defined in claim 7 wherein said personal imaging repository further comprising a converter for converting the imaging data to any of said plurality of file formats.

9. The system as defined in claim 7 wherein said plurality of file formats of said personal imaging repository is any one from the group consisting of:
Joint Photographic Experts Group Format;
Graphics Interchange Format;
Portable Network Graphics Format;
Tagged Image File Format;
Portable Document Format; and,
Microsoft Windows bitmap format.

10. The system as defined in claim 1 wherein said personal imaging repository comprises an imaging data store for storing imaging data.

11. The system as defined in claim 1 wherein said personal imaging repository comprises a plurality of imaging data stores for storing imaging data.

12. The system as defined in claim 11 wherein one of said plurality of imaging data stores is assigned to the user associated with said personal imaging repository for user usage.

13. The system as defined in claim 11 wherein one of said plurality of imaging data stores is assigned to a web service for storing imaging data available to the public.

14. The system as defined in claim 1 wherein said personal imaging repository comprises a composition store for storing imaging compositions of imaging data serviced as a single unit.

15. The system as defined in claim 14 wherein an imaging composition comprises the imaging data or a link to each imaging data.

16. The system as defined in claim 1 wherein said user information is identification and security information used for accessing said personal imaging repository.

17. The system as defined in claim 1 wherein said user information is sent to the requested web service for granting access to said personal imaging repository.

18. The system as defined in claim 1 wherein said user information is stored on the computing device.

19. A method for requesting service for imaging data stored in a personal imaging repository having an imaging data store for storing the imaging data and a composition store for storing imaging compositions having links to the imaging data serviced as a single unit, through a computing device having a browser operably connected to a requested web service, said method comprising the steps of:
requesting service from the requested web service by the computing device;
sending user information to the requested web service;
accessing the personal imaging repository using the user information by the requested web service; and,
servicing the selected imaging data by the requested web service responsive to user selection from the computing device.

20. The method according to claim 19 wherein said step of requesting service further comprising the steps of:
requesting web content from the requested web service by the browser of the computing device;
receiving the request for web content from the browser by the requested web service;
sending web content to the browser by the requested web service responsive to the request for web content;
receiving the web content from the web service by the browser; and,
displaying and executing the web content by the browser.

21. The method according to claim 20 wherein said step of displaying and executing the web content further comprising the steps of:
sending user information to the requested web service by the browser responsive to the web content; and,
directing the browser to a requested web service responsive to the web content.

22. The method according to claim 20 further comprising the steps of:
sending user information to the requested web service; and,
directing the browser to a requested web service responsive to the web content.

23. The method according to claim 19 wherein said step of accessing the personal imaging repository further comprising the steps of:
connecting with the composition store of the personal imaging repository by the web service;
obtaining a list of the imaging composition stored in the composition store by the web service;
constructing a web content including a list of the imaging composition by the web service and control for selecting the available service; and,
sending the constructed web content to the browser by the web service for user selection.

24. The method according to claim 23 further comprising the steps of:
receiving the constructed web content from the web service by the browser; and,
displaying the constructed web content for user selections by the browser.

25. The method according to claim 23 further comprising the steps of:
requesting a selected composition in a specified format from the composition store by the web service responsive to user selection;
receiving a request for user selected composition in a specified format from the web service by the composition store;
obtaining each imaging data indicated by the selected composition from its proper location;
sending the imaging data linked from the user selected composition in the specified format to the web service by the composition store; and,
receiving the imaging data in the specified format from the composition store by the web service.

26. The method according to claim 25 wherein said step of sending the imaging data further comprising the steps of:
determining whether the imaging data needs to be converted into the specified format; and,
converting the imaging data in the specified format when the imaging needs to be converted into the specified format.

27. The method according to claim 19 wherein said step of accessing the personal imaging repository further comprising the steps of:
connecting with the imaging data store of the personal imaging repository indicated from the user information; and,
transferring the imaging data to the imaging data store.

28. The method according to claim 27 further comprising the steps of:
obtaining a link reference of the transferred imaging data stored in the personal imaging data store; and,
disconnecting from the imaging data store by the requested web service.

29. The method according to claim 27 wherein said step of connecting with the imaging data store further comprising the steps of:
determining whether the connection with the imaging data store is successful; and,
returning an error message to the user when the connection is not successful.

30. The method according to claim 27 wherein said step of connecting with the imaging data store further comprising the step of converting the imaging data into a predefined format.

31. The method according to claim 30 wherein said predefined format is any one from the group consisting of:
Joint Photographic Experts Group Format;
Graphics Interchange Format;
Portable Network Graphics Format;
Tagged Image File Format;
Portable Document Format; and,
Microsoft Windows bitmap format.

32. The method according to claim 27 further comprising the steps of:
obtaining a link reference of the transferred imaging data stored in the personal imaging data store;
connecting with the composition store of the personal imaging repository indicated from the user information;
creating an imaging composition having a link reference to the imaging data stored in the personal imaging data store; and,
saving the imaging composition to the composition store.

33. The method according to claim 32 further comprising the steps of:
setting the imaging composition as a selected composition available for service in the composition store; and,
disconnecting from the composition store of the personal imaging repository.

34. The method according to claim 32 wherein prior to the step of creating an imaging composition further comprising the steps of:
determining whether the connection with the composition store is successful; and,
returning an error message to the user when the connection to the composition is not successful.

35. The method according to claim 32 wherein said step of creating an imaging composition further comprising the step of adding the link reference of the imaging data stored in the imaging data store to the imaging composition.

36. A computer program product comprising a computer usable medium having computer readable program codes embodied in the medium that when executed cause a computer to:
request service from the requested web service by the computing device;
send user information to the requested web service;
access the personal imaging repository using the user information by the requested web service; and,
service the selected imaging data by the requested web service responsive to user selection from the computing device.
